(19) United States
(12) Patent Application Publication
(10) Pub. No.: US 2018/0140087 A1
(43) Pub. Date: May 24, 2018

(54) Self-Driving Telescopic Post

(71) Applicant: TCT Nanotec Co., Ltd., Taichung City (TW)

(72) Inventor: Tiger Wu, Taichung City 40755 (TW)

(21) Appl. No.: 15/606,263

(22) Filed: May 26, 2017

(30) Foreign Application Priority Data
Nov. 18, 2016 (TW) 105217652

(51) Int. Cl. A47B 9/20; F16H 25/20; F16M 11/28

(52) U.S. Cl. CPC A47B 9/20; F16M 11/26; F16M 11/28; F16H 25/20

(57) ABSTRACT

A self-driving telescopic post includes a cap, a brake, a directional bearing and an axle. The cap includes comprising a central aperture in communication with a chamber. The brake is inserted in the chamber. The directional bearing is inserted in the cap and engaged with the brake. The axle is inserted in the central aperture and supported by the directional bearing. The axle is allowed to rotate in a first sense of direction relative to the directional bearing so that the brake does not interfere with the rotation of the axle in the first sense of direction via the directional bearing. The axle is prevented from rotation in a second sense of direction relative to the directional bearing so that the brake interferes with the rotation of the axle in the second sense of direction via the directional bearing.

### BACKGROUND OF INVENTION

### 1. Field of Invention

The present invention relates to a telescopic post of a table and, more particularly, to a self-driving telescopic post.

### 2. Related Prior Art

A conventional self-driving telescopic post of a table includes a telescopic unit, a carrier, a transmission unit, and a worm and worm gear for connecting the carrier to the transmission unit. The telescopic unit includes an internal tube movably inserted in an external tube. The transmission unit includes a single threaded rod for driving an internal tube relative to the external tube. Thus, the elevation of the table is changeable. The length of the single threaded rod determines how much the elevation of the table is changeable. However, a long threaded rod means a long period of time for extending the telescopic unit from a minimum length to a maximum length. Moreover, the lifting and lowering of the table is conducted at a same pace. However, lifting of the table at high speed is desired to save a user time while lowering of the table at low speed is desired not to scare a user.

The present invention is therefore intended to obviate or at least alleviate the problems encountered in prior art.

### SUMMARY OF INVENTION

It is the primary objective of the present invention to provide a self-driving telescopic post that is extended at higher speed than shrunk.

To achieve the foregoing objective, the self-driving telescopic post includes a cap, a brake, a directional bearing and an axle. The cap includes comprising a central aperture in communication with a chamber. The brake is inserted in the chamber. The directional bearing is inserted in the cap and engaged with the brake. The axle is inserted in the central aperture and supported by the directional bearing. The axle is allowed to rotate in a first sense of direction relative to the directional bearing so that the brake does not interfere with the rotation of the axle in the first sense of direction via the directional bearing. The axle is prevented from rotation in a second sense of direction relative to the directional bearing so that the brake interferes with the rotation of the axle in the second sense of direction via the directional bearing.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a self-driving telescopic post in accordance with the preferred embodiment of the present invention;

FIG. 2 is a cross-sectional view of the self-driving telescopic post shown in FIG. 1;

FIG. 3 is a perspective of the self-driving telescopic post of FIG. 1 without a telescopic unit;

FIG. 4 is an exploded view of a portion of the self-driving telescopic post shown in FIG. 1;

FIG. 5 is an enlarged partial view of the self-driving telescopic post shown in FIG. 4;

FIG. 6 is an exploded view of another portion of the self-driving telescopic post shown in FIG. 1;

FIG. 7 is an exploded view of another portion of the self-driving telescopic post shown in FIG. 1;

FIG. 8 is a cross-sectional view of an upper portion of the self-driving telescopic post shown in FIG. 1;

FIG. 9 is an exploded view of a lower portion of the self-driving telescopic post shown in FIG. 1; and

FIG. 10 is an enlarged perspective view of an upper portion of the self-driving telescopic post shown in FIG. 1 without a casing.

### DETAILED DESCRIPTION OF PREFERRED EMBODIMENT

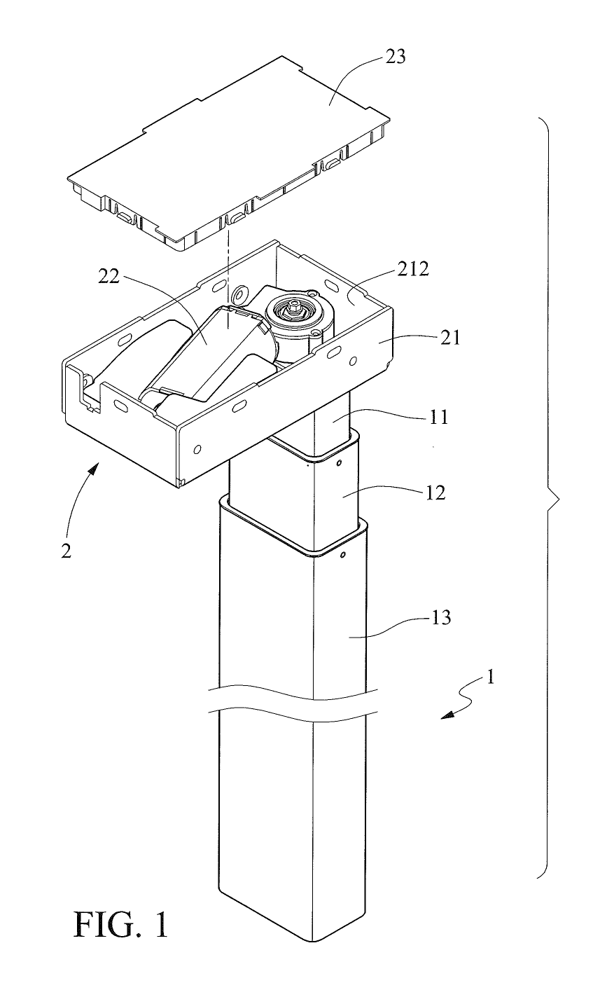

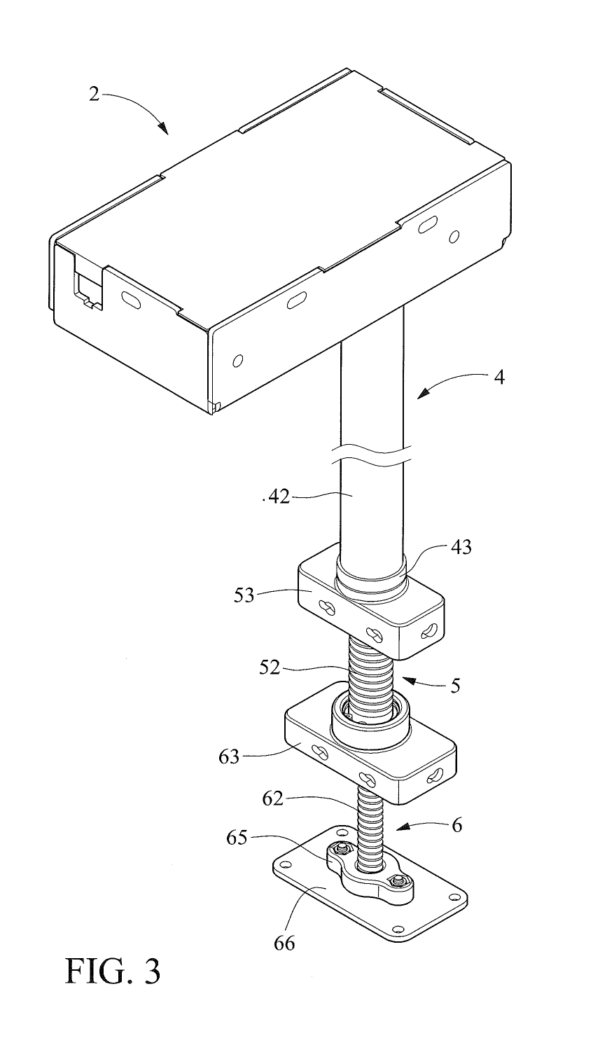

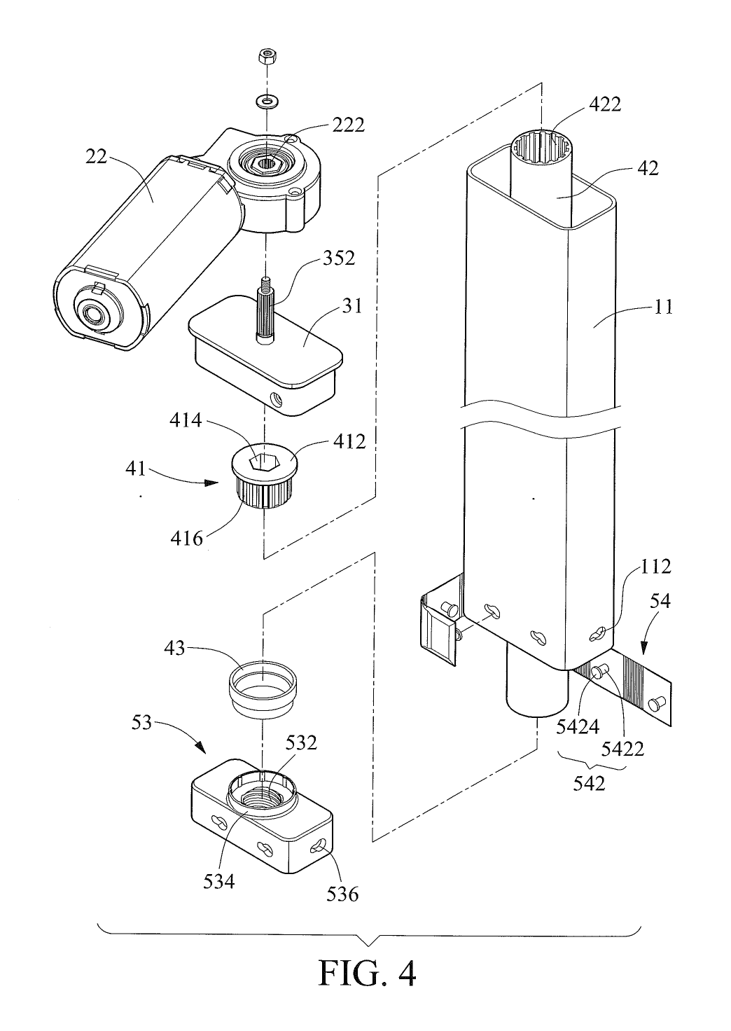

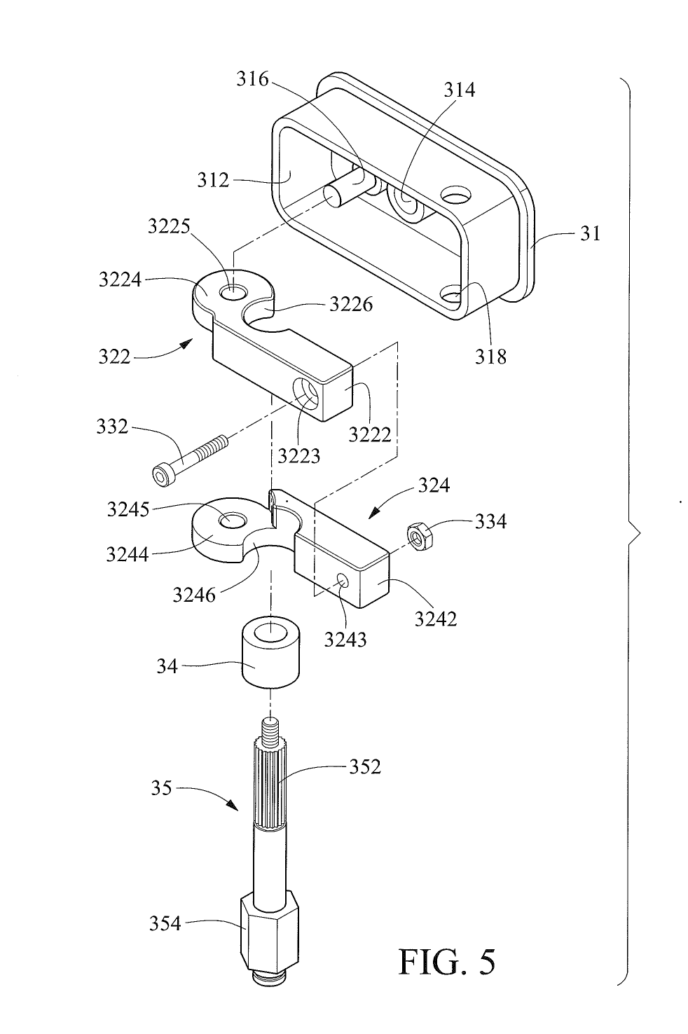

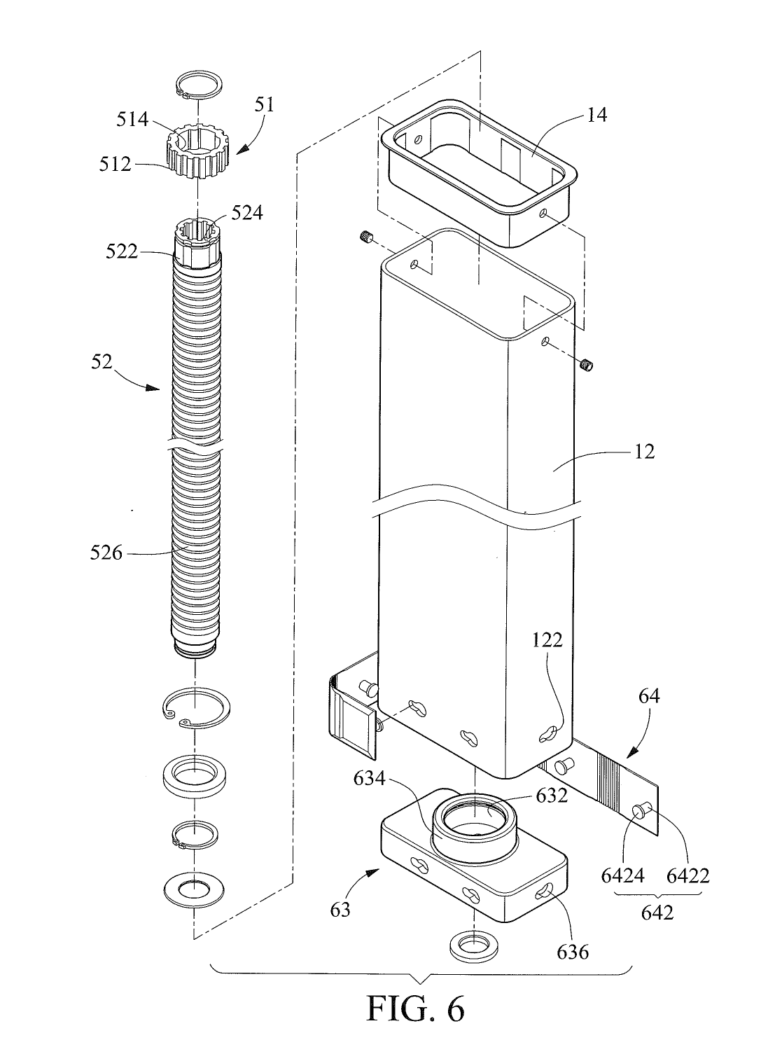

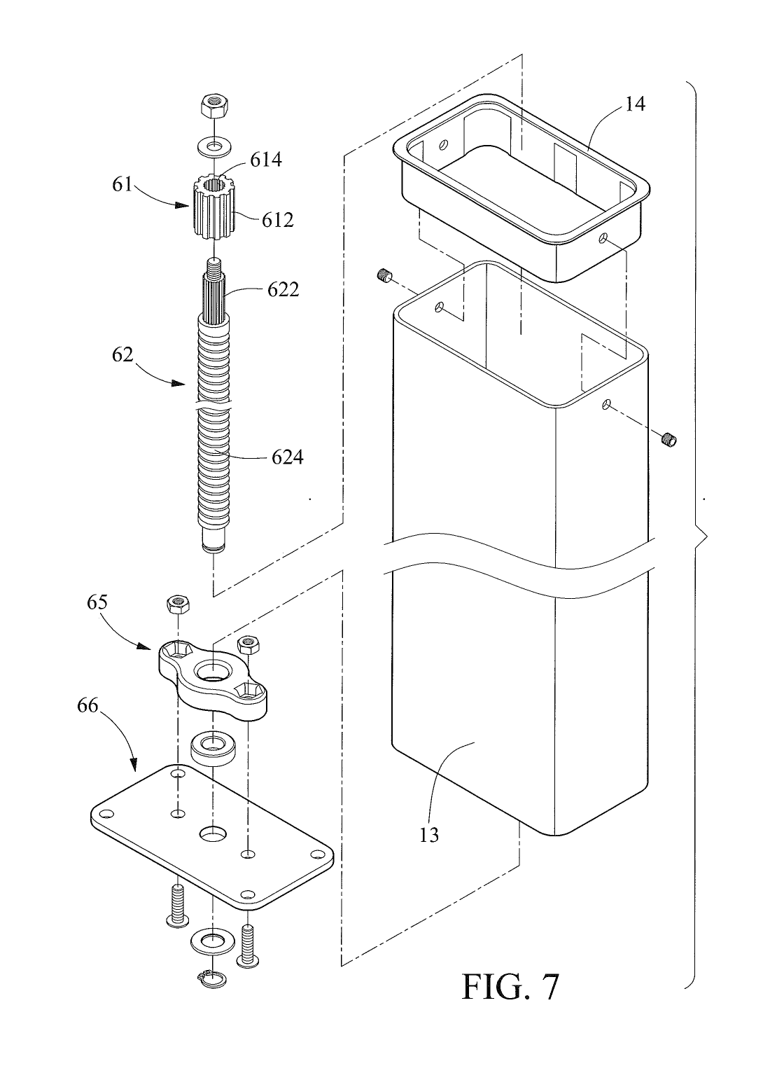

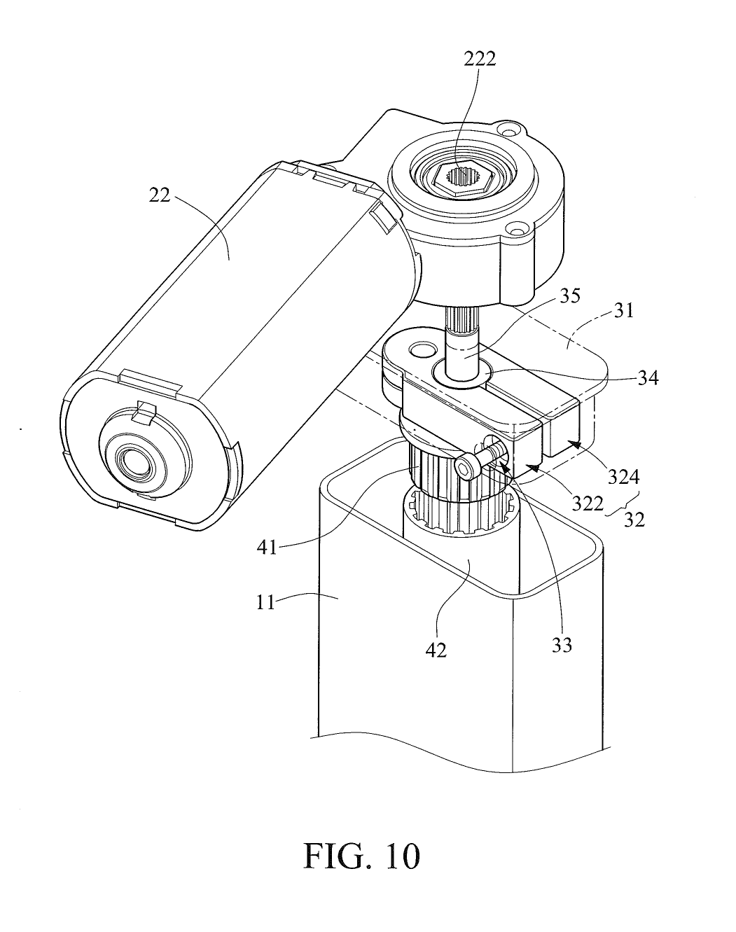

Referring to FIGS. 1 through 10, a self-driving telescopic post includes a telescopic unit 1, a power unit 2, an upper transmission unit 3, a lower transmission unit 4, an internal tube-driving unit 5 and a middle tube-driving unit 6 in accordance with the preferred embodiment of the present invention. The upper transmission unit 3 connects the power unit 2 to the lower transmission unit 4. The upper transmission unit 3 transfers power to the power unit 2 from the lower transmission unit 4. Moreover, the upper transmission unit 3 selectively exerts a braking force.

Referring to FIGS. 1, 2 and 6 to 8, the telescopic unit 1 includes an internal tube 11, a middle tube 12, an external tube 13 and two rings 14. The internal tube 11 includes apertures 112. Each of the apertures 112 includes a larger portion and a smaller portion. The middle tube 12 includes apertures 122. Each of the apertures 122 includes a larger portion and a smaller portion. Each of the apertures 112 is aligned with a corresponding one of the apertures 122. One of the rings 14 is arranged between the internal tube 11 and middle tube 12. The other ring 14 is arranged between the middle tube 12 and the external tube 13. Thus, the internal tube 11, the middle tube 12 and the external tube 13 are separated from one another.

Referring to FIGS. 1 to 4 and 8, the power unit 2 includes a casing 21, a motor 22, a gear 222 and a cover 23. The casing 21 includes a chamber 212 and an aperture 214. The chamber 212 includes an open upper end. The aperture 214 is made in a lower portion of the casing 21. The aperture 214 is shaped in compliance with the profile of the internal tube 11. The casing 21 is attached to an upper end of the internal tube 11, with the upper section of the internal tube 11 extending in the aperture 214. The motor 22 is inserted in the casing 21. The gear 222 is connected to the motor 22. Preferably, the gear 222 is an annular element with teeth (not numbered) formed on an internal face. The gear 222 is aligned with the aperture 214. The cover 23 is located on the casing 21, thereby covering the open upper end of the chamber 212 of the casing 21.

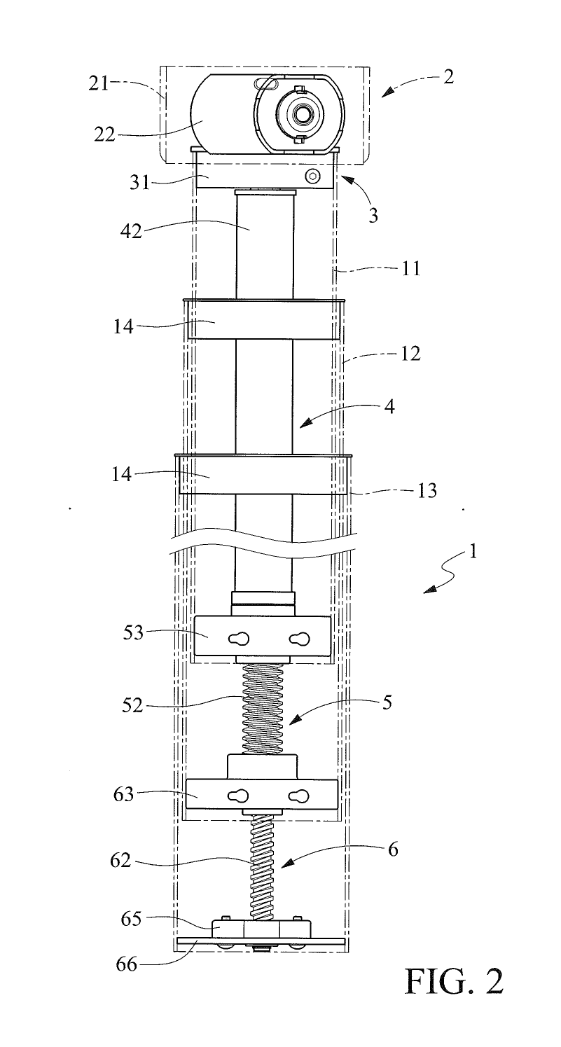

Referring to FIGS. 2 to 5, 8 and 10, the upper transmission unit 3 is connected to the power unit 2 and inserted in the upper section of the internal tube 11. The upper transmission unit 3 includes a cap 31, a brake 32, a fastener 33, a directional bearing 34 and an upper axle 35.

The cap 31 is made with a profile in compliance with an internal face of the internal tube 11. The cap 31 is inserted in an upper open end of the internal tube 11. The cap 31 includes a chamber 312, a central aperture 314, a pivot 316 and two lateral apertures 318. The chamber 312 includes an open lower end. The central aperture 314 is made in an upper portion of the cap 31, in communication with the chamber 312. The central aperture 314 is coaxial with the gear 222 of the motor 22. The pivot 316 projects down from the upper portion of the cap 31, next to the central aperture 314. The lateral apertures 318 are made in the periphery of the cap 31, opposite to each other.

The brake 32 is inserted in the chamber 312. The claim 32 includes a left brake shoe 322 and a right brake shoe 324. The left and right brake shoes 322 and 324 are mirror images of each other. At an end, each of the left and right brake shoes 322 and 324 is pivotally connected to the pivot 316 of the cap 31 so that brake 32 is movable between an open position and a closed position.

The left brake shoe 322 includes a rectilinear portion 3222 at an end, an annular portion 3224 at another end, and a recess 3226 between the rectilinear portion 3222 and the annular portion 3224. The recess 3226 is made in a side of the left brake shoe 322, corresponding to the central aperture 314 of the cap 31. The annular portion 3224 of the left brake shoe 322 includes an aperture 3225, in compliance with the profile of the pivot 316 of the cap 31. The rectilinear portion 3222 of the left brake shoe 322 includes an aperture 3223, corresponding to the lateral apertures 318 of the cap 31. The aperture 3223 is a countersink hole.

The right brake shoe 324 includes a rectilinear portion 3242 at an end, an annular portion 3244 at another end, and a recess 3246 between the rectilinear portion 3242 and the annular portion 3244. The recess 3246 of the right brake shoe 324 is made in a side of the right brake shoe 324, corresponding to the central aperture 314 of the cap 31. The annular portion 3244 of the right brake shoe 324 includes an aperture 3245, in compliance with the pivot 316 of the cap 31. The rectilinear portion 3242 of the right brake shoe 324 includes an aperture 3243, corresponding to the lateral apertures 318 of the cap 31. The aperture 3243 is a countersink hole.

In assembly, the annular portion 3224 of the left brake shoe 322 is located on the rectilinear portion 3242 of the right brake shoe 324. The pivot 316 is inserted in the lateral apertures 3225 and 2345.

The fastener 33 includes a threaded bolt 332 and a nut 334. The threaded bolt 332 is inserted in the aperture 3223 of the left brake shoe 322 and the aperture 3243 of the right brake shoe 324 and then engaged with the nut 334. The fastener 33 is operable to change the angle between the rectilinear portion 3222 of the left brake shoe 322 and the rectilinear portion 3242 of the right brake shoe 324.

The directional bearing 34 is partially inserted in the recess 3226 of the left brake shoe 322 and partially inserted in the recess 3246 of the right brake shoe 324. The directional bearing 34 is in contact with the left and right brake shoes 322 and 324.

The upper axle 35 is a solid element formed with a section inserted in the directional bearing 34, an end connected to the gear 222, and another end connected to the lower transmission unit 4. The upper axle 35 includes teeth 352 near an end and a polygonal portion 354 near another end. The upper axle 35 is partially inserted in the gear 222. The teeth 352 are engaged with the teeth of the gear 222 so that the upper axle 35 is rotatable with the gear 222.

Referring to FIGS. 2 to 4 and 8, the lower transmission unit 4 is partially inserted in the internal tube 11. The lower transmission unit 4 includes a joint 41, a lower axle 42 and a ring 43.

The joint 41 is an annular element inserted in an upper end of the lower axle 42. The joint 41 includes an annular flange 412, a polygonal aperture 414 and teeth 416. The annular flange 412 extends on and around the joint 41. The annular flange 412 is located against the upper end of the lower axle 42. The polygonal aperture 414 is centrally made in the joint 41. The polygonal aperture 414 of the joint 41 receives the polygonal portion 354 of the upper axle 35 so that the joint 41 is rotatable with the upper axle 35. The teeth 416 are formed on an internal face of the joint 41.

The lower axle 42 is a tubular element that includes teeth 422 formed on an internal face. The teeth 422 of the lower axle 42 are engaged with the teeth 416 of the joint 41 so that lower axle 42 is rotatable with the joint 41. The teeth 422 extend for the entire length of the lower axle 42.

A lower end of the lower axle 42 is rotationally inserted in the ring 43.

Referring to FIGS. 2 to 4, 6 and 9, the internal tube-driving unit 5 includes a joint 51, a transmitting tube 52, a carrier 53 and an abrasion-resistant strip 54.

The joint 51 is movably inserted in the lower axle 42. The joint 51 is an annular element formed with external teeth 512 and internal teeth 514. The external teeth 512 are engaged with the teeth 422 of the lower axle 42 so that the joint 51 is rotatable with the lower axle 42.

The transmitting tube 52 is partially inserted in the lower axle 42. The transmitting tube 52 includes external teeth 522, internal teeth 524 and a thread 526. The external teeth 522 are formed on an upper section of the transmitting tube 52. The external teeth 522 of the transmitting tube 52 are engaged with the internal teeth 514 of the joint 51 so that the transmitting tube 52 is rotatable with the joint 51. The internal teeth 524 extend for the entire length of the transmitting tube 52. The thread 526 extends on an external face of the transmitting tube 52.

The carrier 53 is inserted in a lower end of the internal tube 11. The carrier 53 includes a screw hole 532, a socket 534 and apertures 536. The screw hole 532 extends throughout the carrier 53. The screw hole 532 receives the thread 526 of the transmitting tube 52. The socket 534 is formed on an upper face of the carrier 53, coaxial with the screw hole 532. The apertures 536 are made in the periphery of the carrier 53, corresponding to the apertures 112. Each of the apertures 536 includes a larger portion and a smaller portion.

The abrasion-resistant strip 54 is a flexible strip formed with internal tube connectors 542, corresponding to the apertures 112 and the apertures 536. Each of the internal tube connectors 542 includes a stem 5422 extending from an internal face of the abrasion-resistant strip 54 and a head 5424 formed at a free end of the stem 5422. The head 5424 is in the form of a mushroom head or a sphere or in any other proper shape. The internal tube connectors 542 are inserted in the apertures 536 and 112 to connect the carrier 53 to the internal tube 11.

Referring to FIGS. 2, 3, 6 and 7 to 9, the middle tube-driving unit 6 includes a joint 61, a transmitting rod 62, a carrier 63, an abrasion-resistant strip 64 and a bearing 65.

The joint 61 is movably inserted in the transmitting tube 52. The joint 61 is an annular element formed with external teeth 612 and internal teeth 614. The external teeth 612 are engaged with the internal teeth 524 so that the joint 61 is rotatable with the transmitting tube 52 and that the joint 61 is movable relative to the transmitting tube 52.

The transmitting rod 62 includes teeth 622 formed on an upper section and a thread 624 formed on a middle section. The teeth 622 are engaged with the internal teeth 614 so that the transmitting rod 62 is rotatable with the joint 61.

The carrier 63 is inserted in a lower end of the middle tube 12. The carrier 63 includes a screw hole 632, a socket 634 and apertures 636. The screw hole 632 extends throughout the carrier 63. The screw hole 632 receives the thread 624 so that the carrier 63 is moved relative to the transmitting rod 62 when the transmitting rod 62 is rotated relative to the carrier 63. The socket 634 is formed on an upper face of the carrier 63, coaxial with the screw hole 632. The socket 634 receives a bearing D1. The bearing D1 supports a lower end of the transmitting tube 52. Each of the apertures 636 includes a larger portion and a smaller portion. Each of the apertures 636 is aligned with a corresponding one of the apertures 122.

The abrasion-resistant strip 64 is a flexible strip formed with middle tube connectors 642, corresponding to the apertures 122 and 636. Each of the middle tube connectors 642 includes a stem 6422 extending from an internal side of the abrasion-resistant strip 64 and a head 6424 formed at a free end of the stem 6422. The head 6424 is in the form of a mushroom head or a sphere or in any other proper shape. The middle tube connectors 642 are inserted in the apertures 636 and 122 to connect the carrier 63 to the middle tube 12.

As mentioned above, the carrier 63 is moved relative to the transmitting rod 62 when the transmitting rod 62 is rotated relative to the carrier 63 since the screw hole 632 receives the thread 624. Moreover, the carrier 63 drives the middle tube 12 because the carrier 63 is connected to the middle tube 12. It should be noted that the threads 526 and 624 must extend in opposite senses of direction. In the preferred embodiment, the thread 526 is a left-hand thread, and the thread 624 a right-hand thread. However, in another embodiment, the thread 526 can be a right-hand thread, and the thread 624 a left-hand thread.

The bearing 65 is connected to a plate 66 which is attached to a lower end of the external tube 13. The bearing 65 supports a lower end of the transmitting rod 62. Thus, the transmitting rod 62 is rotatable but not translatable relative to the plate 66 and hence the external tube 13.

The operation of the self-driving telescopic post for supporting a table (not shown) will be described. The box 21, which is attached to an upper end of the telescopic unit 1, is attached to a lower face of the table. A lower end of the telescopic unit 1 is supported on a floor (not shown).

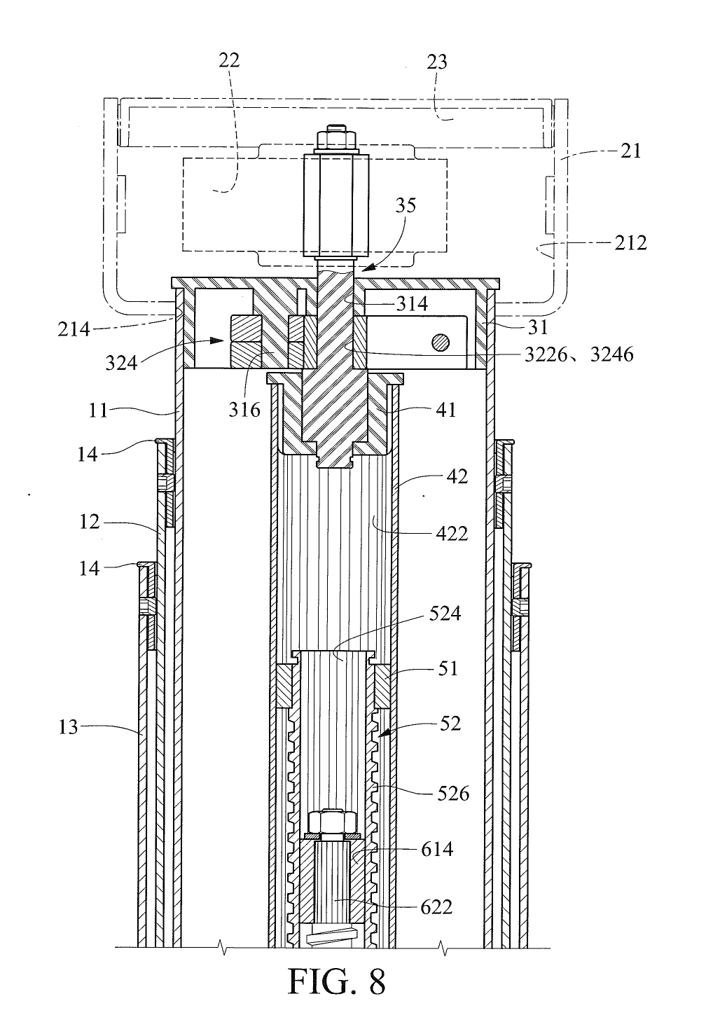

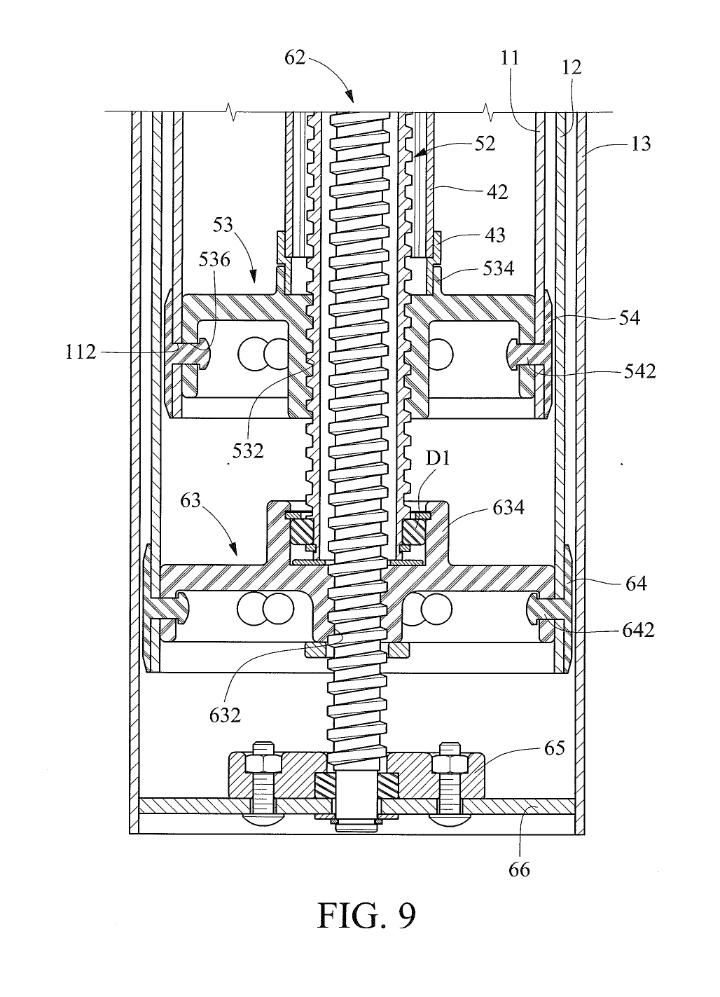

Referring to FIGS. 8 and 9, to change the height of the table, the motor 22 of the power unit 2 is turned on to rotate the upper axle 35 in a first sense of direction via the gear 222. The rotation of the upper axle 35 is not interrupted by the directional bearing 34, which is provided around the upper axle 35. The upper axle 35 rotates the lower transmission unit 4.

The lower transmission unit 4 rotates the internal tube-driving unit 5 because the lower axle 42 is connected to the transmitting tube 52 in via the joint 51. It should be noted that the lower axle 42 is prevented from rotation relative to the transmitting tube 52 but they are allowed to translate relative to each other. The transmitting tube 52 lifts the carrier 53 relative thereto as the thread 526 is inserted in screw hole 532. The carrier 53 lifts the internal tube 11 relative to the middle tube 12 since the carrier 53 is connected to the internal tube 11 by the fasteners 542 and the transmitting tube 52 is supported on the carrier 63, which is connected to the middle tube 12 by the fasteners 642.

The internal tube-driving unit 5 rotates the middle tube-driving unit 6 since the transmitting tube 52 is connected to the transmitting rod 62 via the joint 61. The transmitting rod 62 lifts the carrier 63 because the thread 624 is inserted in the screw hole 632. The carrier 63 lifts the middle tube 12 relative to the external tube 13 since the carrier 63 is connected to the middle tube 12 by the fasteners 642 and the transmitting rod 62 is supported on the bearing 65, which is supported on the plate 66, which is connected to the lower end of the external tube 13.

As discussed above, the internal tube 11 is lifted relative to the middle tube 12 by the internal tube-driving unit 5 while the middle tube 12 is lifted relative to the external tube 13 by the middle tube-driving unit 6. Hence, the speed of the lifting of the table relative to the floor is the speed of the lifting of the internal tube 11 relative to the middle tube 12 plus the speed of the lifting of the middle tube 12 relative to the external tube 13. Hence, the lifting of the table relative to the floor is fast.

Referring to FIGS. 8 to 10, to lower the table relative to the floor, the motor 22 of the power unit 2 is turned on to rotate the upper axle 35 in a second sense of direction opposite to the first sense of direction. The directional bearing 34 prevents the upper axle 35 from rotation in the second sense of direction relative thereto. Hence, the directional bearing 34 is rotated in the second sense of direction with the upper axle 35. The brake 32 interferes with the rotation of the bearing 34 and hence the upper axle 35 in the second sense of direction. Hence, the lowering of the table relative to the floor is conducted at lower speed than the lifting.

The transmission unit 4, the internal tube-driving unit 5 and the middle tube-driving unit 6 are operated in a sense of direction opposite to that occurs in the lifting of the table relative to the floor. Hence, the operation of the transmission unit 4, the internal tube-driving unit 5 and the middle tube-driving unit 6 to lower the table relative to the floor will not be described in detail for briefness.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A self-driving telescopic post comprising a telescopic unit (1) and an upper transmission unit (3) comprising:
a cap (31) inserted in the telescopic unit (1), and comprising a chamber (312) and a central aperture (314) in communication with the chamber (312);
a brake (32) inserted in the chamber (312);
a directional bearing (34) inserted in the cap (31) and engaged with the brake (32); and
an upper axle (35) inserted in the central aperture (314) and supported by the directional bearing (34), wherein the upper axle (35) is allowed to rotate in a first sense of direction relative to the directional bearing (34) so that the brake (32) does not interfere with the rotation of the upper axle (35) in the first sense of direction via the directional bearing (34), wherein the upper axle (35) is prevented from rotation in a second sense of direction relative to the directional bearing (34) so that the brake (32) interferes with the rotation of the upper axle (35) in the second sense of direction via the directional bearing (34).

2. The self-driving telescopic post in accordance with claim 1, wherein the brake (32) comprises two brake shoes (322, 324) pivotally connected to cap (31), wherein the directional bearing (34) is located between the brake shoes (322, 324).

3. The self-driving telescopic post in accordance with claim 2, wherein each of the brake shoes (322, 324) comprises an annular portion (3224, 3244) at an end and a recess (3226, 3246) near the annular portion (3224, 3244), wherein the cap (31) comprises a pivot (316) inserted in the annular portions (3224, 3244) of the brake shoes (322, 324), wherein the upper axle (35) is inserted in the recesses (3226, 3246) of the brake shoes (322, 324).

4. The self-driving telescopic post in accordance with claim 3, wherein the rectilinear portion (3222, 3242) of each of the brake shoes (322, 324) comprises an aperture (3223, 3243), wherein the brake (32) comprises a fastener (33) inserted in the apertures (3223, 3243) of the brake shoes (322, 324).

5. The self-driving telescopic post in accordance with claim 1, wherein the telescopic unit (1) comprises an external tube (13), a middle tube (12) movably inserted in the external tube (13), and an internal tube (11) movably inserted in the middle tube (12).

6. The self-driving telescopic post in accordance with claim 5, comprising a lower transmission unit (4) inserted in the internal tube (11) and connected to the upper axle (35), wherein the lower transmission unit (4) comprises a lower axle (42) and a joint (41) for connecting the lower axle (42) to the upper axle (35) so that the lower axle (42) is rotatable with the upper axle (35).

7. The self-driving telescopic post in accordance with claim 6, wherein the joint (41) comprises a polygonal aperture (414) made therein and teeth (416) formed thereon, wherein the upper axle (35) comprises a polygonal section (354) inserted in the polygonal aperture (414), wherein the lower axle (42) comprises, on an internal face, teeth (422) engaged with the teeth (416) of the joint (41).

8. The self-driving telescopic post in accordance with claim 6, comprising an internal tube-driving unit (5) comprising:
a joint (51) inserted in the lower axle (42) so that they are translatable but not rotatable relative to each other;
a transmitting tube (52) connected to the joint (51) so that they are not rotatable relative to each other, wherein the transmitting tube (52) comprises a thread (526) formed thereon; and
an internal tube carrier (53) inserted in a lower end of the internal tube (11) so that they are not movable relative to each other, wherein the internal tube carrier (53) comprises a screw hole (532) for receiving the thread (526) of the transmitting tube (52) so that the internal tube carrier (53) and hence the internal tube (11) are translated when the transmitting tube (52) is rotated relative to the internal tube carrier (53).

9. The self-driving telescopic post in accordance with claim 8, wherein the joint (51) comprises external teeth (512) and internal teeth (514), wherein the lower axle (42) comprises teeth (422) engaged with the external teeth (512) of the joint (51), wherein the transmitting tube (52) comprises teeth (522) engaged with the internal teeth (514) of the joint (51).

10. The self-driving telescopic post in accordance with claim 8, wherein the internal tube-driving unit (5) comprises at least one fastener (542) for connecting the internal tube carrier (53) to the internal tube (11).

11. The self-driving telescopic post in accordance with claim 10, wherein the internal tube carrier (53) comprises at least one aperture (536) for receiving the faster (542), wherein the internal tube (11) comprises at least one aperture (112) for receiving the fastener (542).

12. The self-driving telescopic post in accordance with claim 10, wherein the internal tube-driving unit (5) comprises several fasteners (542) for connecting the internal tube carrier (53) to the internal tube (11).

13. The self-driving telescopic post in accordance with claim 12, wherein the internal tube-driving unit (5) comprises an abrasion-resistant strip (54) located around the internal tube (11), wherein the fasteners (542) are formed on a side of the abrasion-resistant strip (54).

14. The self-driving telescopic post in accordance with claim 8, comprising a middle tube-driving unit (6) comprising:
a joint (61) inserted in the transmitting tube (52) so that they are translatable but not rotatable relative to each other;
a transmitting rod (62) connected to the joint (61) of the middle tube-driving unit (6) so that they are not rotatable relative to each other, wherein the transmitting rod (62) comprises a thread (624) formed thereon; and
a middle tube carrier (63) inserted in a lower end of the middle tube (12) so that they are not movable relative to each other, wherein the middle tube carrier (63) comprises a screw hole (632) for receiving the thread (624) of the transmitting rod (62) so that the middle tube carrier (63) and hence the middle tube (12) are translated when the transmitting rod (62) is rotated relative to the middle tube carrier (63).

15. The self-driving telescopic post in accordance with claim 14, wherein the joint (61) of the middle tube-driving unit (6) is an annular element formed with external teeth (612) and internal teeth (614), wherein the transmitting tube (52) comprises teeth (524) engaged with the external teeth (512) of the joint (61) of the middle tube-driving unit (6), wherein the transmitting rod (62) comprises teeth (622) engaged with the internal teeth (614) of the joint (61) of the middle tube-driving unit (6).

16. The self-driving telescopic post in accordance with claim 14, wherein the middle tube-driving unit (6) comprises at least one fastener (642) for connecting the middle tube carrier (63) to the middle tube (12).

17. The self-driving telescopic post in accordance with claim 16, wherein the middle tube carrier (63) comprises at least one aperture (636) for receiving the faster (642) of the middle tube-driving unit (6), wherein the middle tube (12) comprises at least one aperture (122) for receiving the fastener (642) of the middle tube-driving unit (6).

18. The self-driving telescopic post in accordance with claim 16, wherein the internal tube-driving unit (5) comprises several fasteners (542) for connecting the internal tube carrier (53) to the internal tube (11).

19. The self-driving telescopic post in accordance with claim 18, wherein the internal tube-driving unit (5) comprises an abrasion-resistant strip (54) located around the internal tube (11), wherein the fasteners (542) are formed on a side of the abrasion-resistant strip (54).

20. The self-driving telescopic post in accordance with claim 14, wherein the middle tube-driving unit (6) comprises a bearing (65) for supporting the transmitting rod (62), wherein the bearing (65) is inserted in the external tube (13).
